(19) United States
(12) Patent Application Publication
(10) Pub. No.: US 2012/0005152 A1
(43) Pub. Date: Jan. 5, 2012

(54) Merged Event Logs

(76) Inventors: Peter Westen, Mountain View, CA (US); Justin Mcleod North Wood, Sunnyvale, CA (US)

(21) Appl. No.: 12/829,292

(22) Filed: Jul. 1, 2010

(51) Int. Cl. G06F 17/30

(52) U.S. Cl. 707/602; 707/E17.009

(57) ABSTRACT

A record of an event is received in a common format. The record includes a time of the event, a type of the event, and an identity of a device that created the record in the common format using an event creation module selected based on the type of the event. A collection of records including the received record is managed, and a portion of the collection of records is provided in response to a user request. The portion is configured to be sorted according to user-configurable criteria and includes records with a plurality of types.

### FIELD OF THE INVENTION

Embodiments of the invention are generally directed to logging events, and more particularly toward maintaining a collection of events from multiple services and/or devices.

### BACKGROUND

There are many forms of electronic communication between two or more people, and each form of communication generates its own type of events. For example, a user of a cell phone may exchange text message events with another user of a cell phone. The users may also exchange phone calls, multimedia messages, files, video chat, and other forms of communication using cell phones or other data processing devices. Social networking systems also generate events. For example, status updates such as, “John and Sue are now friends,” invitations and responses to invitations, etc. Generally, each of these forms of communication are provided by a different service and/or a different server, making it difficult to maintain a coherent history of events across different devices, communication services, and time.

### SUMMARY

In one embodiment, a record of an event is received in a common format. The record includes a time of the event, a type of the event, and an identity of a device that created the record in the common format using an event creation module selected based on the type of the event. A collection of records including the received record is managed, and a portion of the collection of records is provided in response to a user request. The portion is configured to be sorted according to user-configurable criteria and includes records with a plurality of types.

### BRIEF DESCRIPTION OF THE DRAWINGS

The present invention is illustrated by way of example and not limitation in the figures of the accompanying drawings in which like references indicate similar elements.

FIG. 1 is a diagram illustrating multiple devices communicating with a server according to an embodiment of the invention;

FIG. 2 is a flow chart illustrating a method of receiving universal event records from user devices and providing requested portions of the historical collection according to an embodiment of the invention;

FIG. 3 is a flow chart illustrating a method of reporting events to an event tracking service according to an embodiment of the invention;

FIG. 4 is a diagram illustrating a universal event record format according to an embodiment of the invention;

FIG. 5 is a diagram illustrating the display of a requested portion of a user's historical collection according to an embodiment of the invention;

FIG. 6 is diagram illustrating the display of another portion of a user's historical collection according to an embodiment of the invention;

FIG. 7 is a timing diagram illustrating an overall collection view of received events according to an embodiment of the invention;

FIG. 8 is a diagram of a data processing system that may be used with embodiments of the invention; and

FIG. 9 is a diagram of a device that may be used with embodiments of the invention.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to one embodiment or an embodiment means that a particular feature, structure or characteristic described in connection with the embodiment is included in at least one embodiment of the invention. The appearance of the phrase “in one embodiment” in various places in the specification do not necessarily refer to the same embodiment.

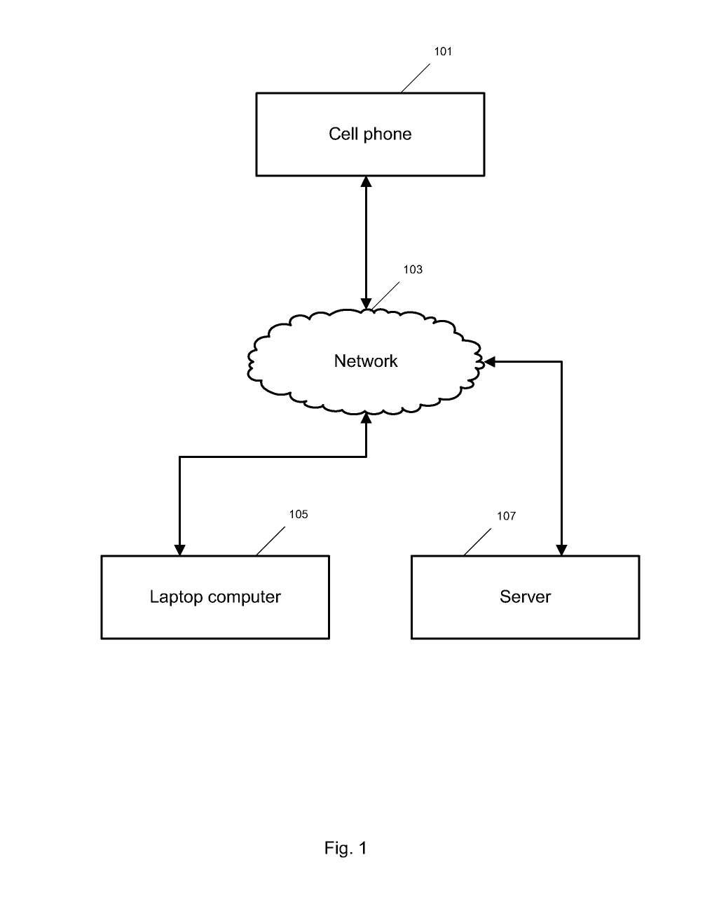

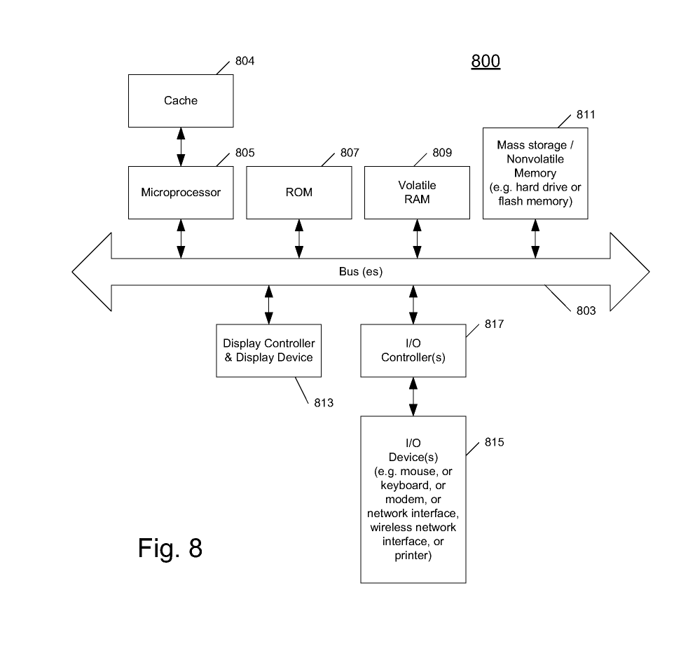

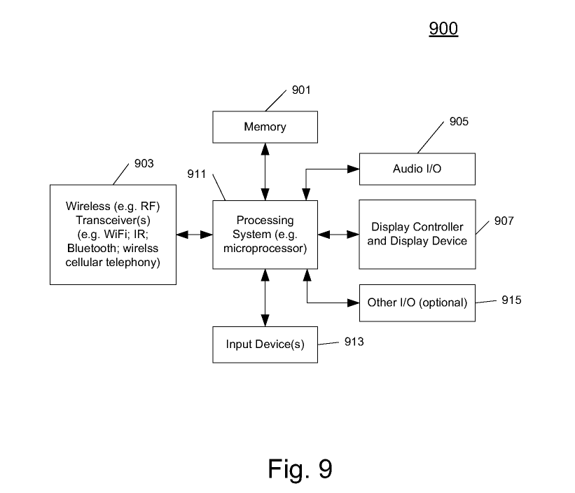

In one embodiment, a universal communication history is provided. For example, two users, A and B, communicate with each other through various data processing systems. The various data processing systems may include a cellular telephone, a desktop computer, a laptop computer, a tablet computer, etc. FIGS. 8 and 9 illustrate two possible embodiments of devices configured to work with the universal communication history. Each device may provide multiple communication services, such as an instant message service, voice/telephone service, electronic mail, video chat, file transfers, text messages, etc. One or both users may have an account with an event tracking service. The event tracking service may take the form of a remote data processing system (e.g., a server reachable through the Internet). Multiple devices communicating with an event tracking service is described in greater detail below in conjunction with FIG. 1.

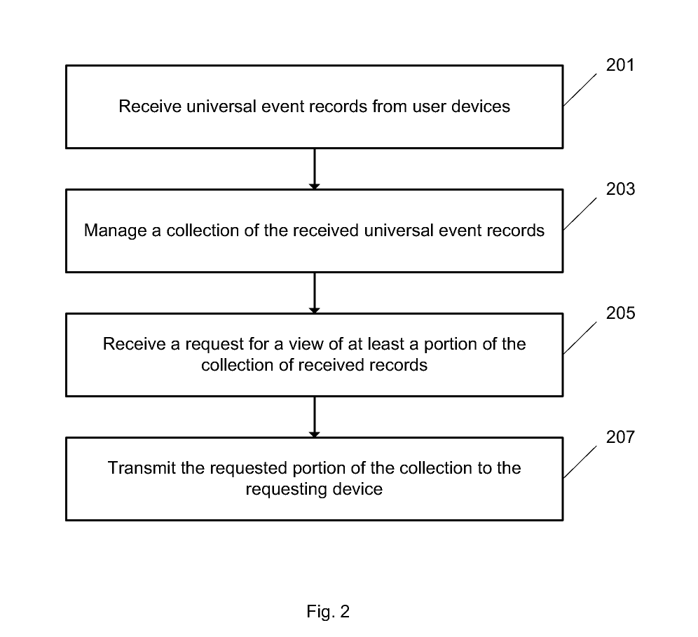

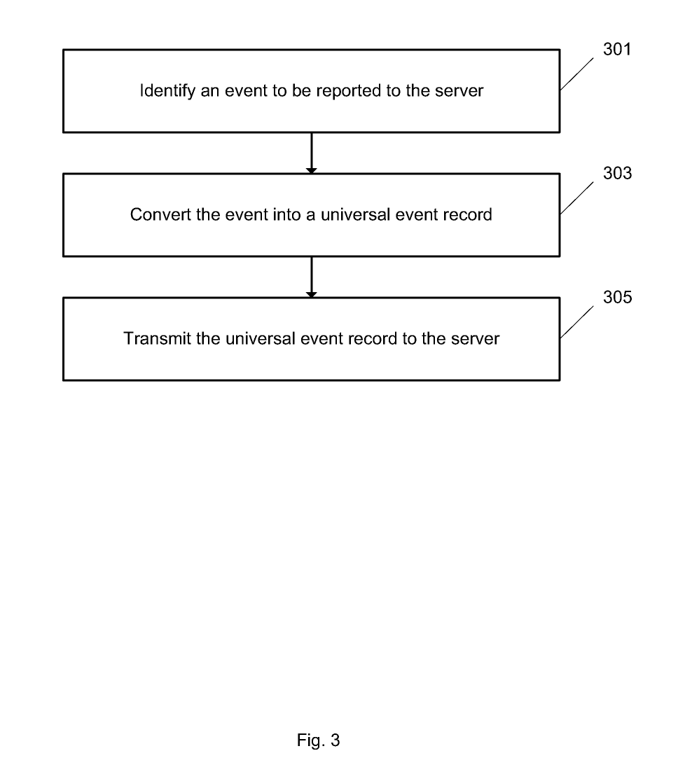

Each user device may include a universal event record generator capable of converting events from the communication services into an universal event record format. When a device receives or sends an event using one of the communication services, the device may cause the universal event record generator to convert the service-specific event into a universal event record (UER). The device may send the UER to a server or other data processing system of the event tracking service as described below in greater detail in conjunction with FIG. 3. The event tracking service receives the UER and adds it to a historical collection of events associated with the user. Receipt of UER's from user devices is described in greater detail below in conjunction with FIG. 2.

Each of the user devices may also include a history viewing service which allows the user to request all or a portion of the historical collection from the event tracking service. The requested portion of the historical collection is provided to the user through the history viewing service on the user device. The user may specify various orderings of the received history. For example, the user may request that the received history be sorted in the chronological order in which the events occurred. The user may request that the received history be filtered by device, message service, or other criteria.

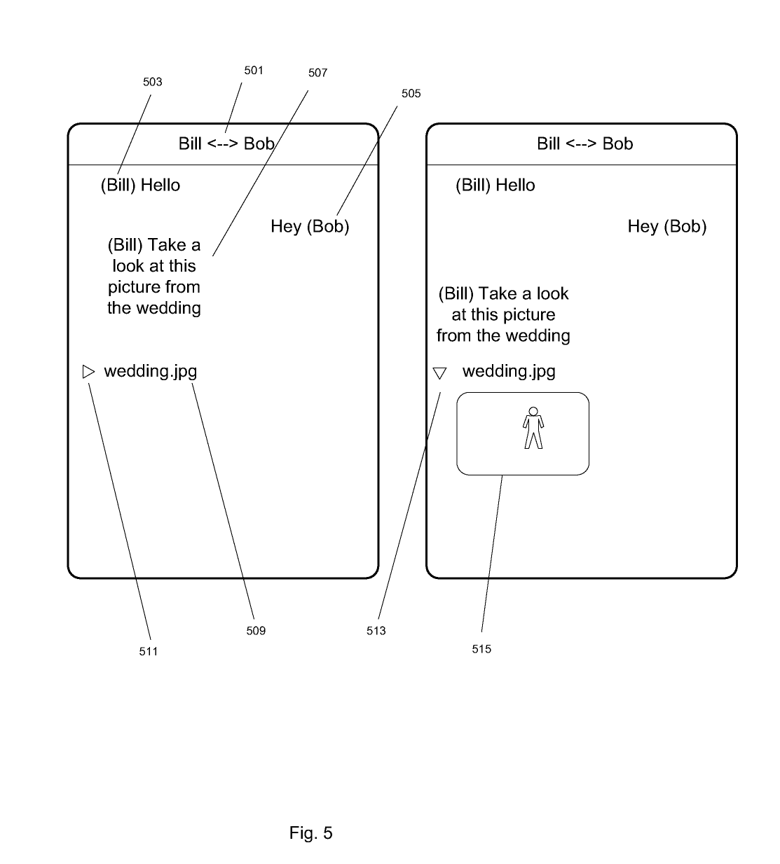

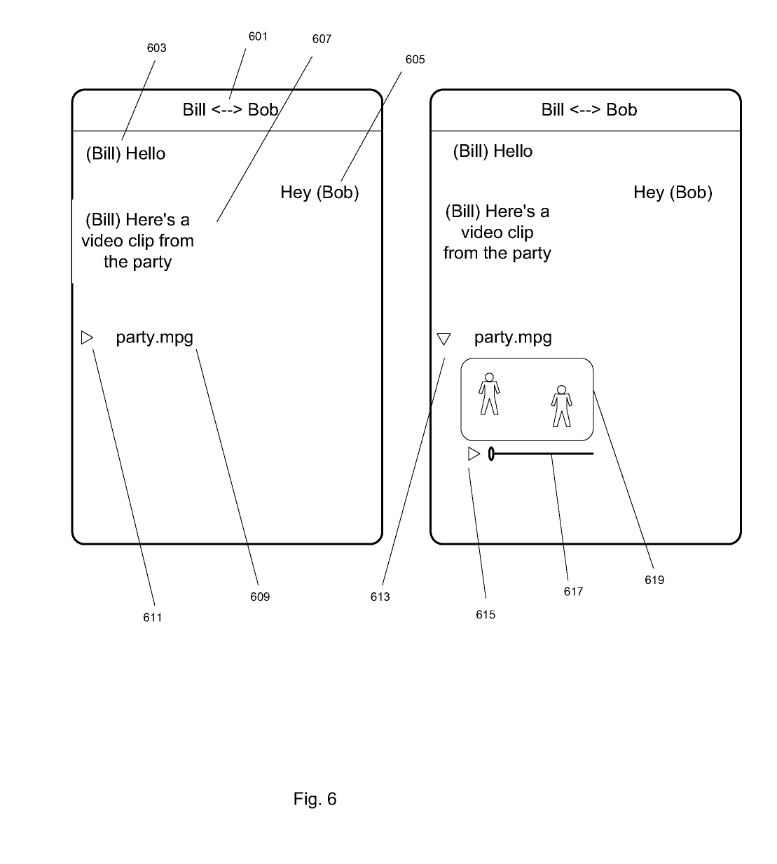

Each event sent or received by a messaging service available on one of the user devices may be converted into a UER and sent to the event tracking service. The historical collection interleaves UER's arising from multiple message services. A portion of the historical collection may include events from multiple message services. For example, a portion may include text messages, video chats, and transferred files in the chronological order that they occurred. Interleaving events of different types is described in greater detail below in conjunction with FIGS. 5 and 6.

Turning now to FIG. 1, which is a diagram illustrating multiple devices (cell phone 101 and laptop computer 105) which communicate with a server 107 through network 103. Cell phone 101, for example, may send and receive text messages (e.g., SMS), multimedia messages (e.g., MMS), email, phone calls (e.g., cellular telephony, voice over IP, etc.), and other forms of communication. Cell phone 101 may take pictures or video using an internal camera and transfer the pictures or video to another device through a wireless internet connection or a cellular data connection. Other forms of communication are also possible. Each use of one of these communication services represents a potential event. In one embodiment, events of any of these services are converted into a UER and sent by cell phone 101 to an event tracking service provided by server 107 through network 103. In other embodiments, a subset of the events is sent. For example, a user may configure cell phone 101 to generate UER's for text messages but not for emails. In addition to filtering by communication service, the user may generate UER's based on an identity of a sender or receiver. For example, messages to and from a co-worker may not be reported to server 107, while messages to and from a friend may be reported. Other filters are possible and may be configured through user-accessible options, an enterprise device provisioning service, or other type of configuration. For example, an enterprise device (e.g., employer provided laptop computer) may specify that communication between employees generate UER's according to enterprise-specific rules. In another embodiment, the user has segregated histories on the server 107. For example, a first history may store communication events between the user and co-workers, while a second history stores events between the user and friends. Other divisions are also possible.

Laptop computer 105 may provide a similar set of communication services as provided by cell phone 101. Alternatively, laptop computer 105 may provide a different set of communication services than cell phone 101. The provided services may overlap, for example, both cell phone 101 and laptop computer 105 may provide voice over IP telephone services. Network 103 may include several data networks. Network 103 may include a cellular telephone network, a cellular data network (e.g., EDGE), and a TCP/IP network (e.g., LAN, WAN, etc.). Other networks may be included as well. Server 107 may be implemented as one or more data processing systems providing an event tracking service.

Cell phone 101 and laptop computer 105 may send UER's to server 107 through network 103 for inclusion in one or more historical collections. Cell phone 101 and laptop computer 105 may also transmit history requests through network 103 to server 107. Server 107 may transmit the requested portion of the historical collection to the requesting device (e.g., cell phone 101 or laptop computer 105).

In one embodiment, the server 107 has no direct knowledge of the various communication services used by the user device. For example, the user device may send and receive SMS messages through a cellular provider, send and receive emails through an email server, and send and receive instant messages through an instant message server, while files may be transferred in a peer to peer fashion from one user device through a network to another user device. The server 107 may not be involved in these communication paths. The server 107 maintains its historical collection of communication events by receiving UER's from the user devices.

The requesting device may use a history viewing service to display the requested portion of the historical collection. In one embodiment, the requested portion is sorted by the server 107 before being sent to the requesting device. In another embodiment, the requested portion is sorted by the requesting device. In still another embodiment, the requested portion is sorted to an initial requested criteria before being sent to the requesting device, and the requesting device is configured to re-sort the requested portion according in response to user input. For example, the requested portion may be initially sorted in chronological order, and after receipt, the requested device may cause the requested portion to be re-sorted according to event type.

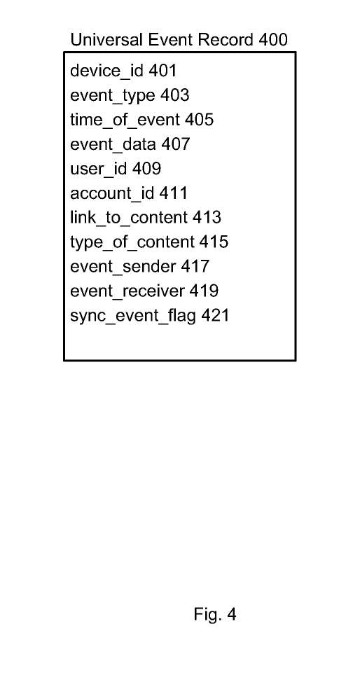

FIG. 2 is a flow chart illustrating a method of receiving UER's from user devices and providing requested portions of the historical collection. The method may be performed by server 107 in FIG. 1. At block 201, the method receives universal event records (UER's) from user devices, such as cell phone 101 and laptop computer 105 in FIG. 1. The received records may be in the universal format illustrated in FIG. 4 and described in greater detail below. At block 203, the method manages the collection of the received universal event records. Managing the collection may include storing the records on the server and organizing the events according to various criteria. For example, managing the collection may include interleaving the records in a chronological fashion regardless of the communication service that generated the records. For example, if a text message occurs at time T1, a video chat occurs at time T2, and a second text message occurs at time T3, where T1<T2<T3, the chronological order, independent of the originating communication service, would be the first text message, the video chat, and then the second text message.

At block 205, the method receives a request for a view of at least a portion of the collection of received records. For example, the method may receive a request for events occurring on a particular day between two users. Generally, requests may include a default filter limiting the requested portion of the historical collection to communications between two users, since this encapsulates the idea of a “conversation.” However, this filter is optional. A user may request all communications in one of their historical collections. Also, a user may request communications amongst several users. For example, a user may have participated in a chat room provided by an instant message communication service. The user may request a portion of the historical collection corresponding to the messages sent and received by users participating in the chat room. The messages from the chat room may be included in the historical collection because the user participated in the chat room using an instant message service, even though the messages in the chat room may not be directly addressed to the user.

At block 207, the method transmits the requested portion of the collection to the requesting device. As described above, the method may sort the requested portion prior to transmitting it to the requesting device. The events received at block 201 may be generated by a user device after sending, receiving, or otherwise generating an event.

FIG. 3 illustrates a method of reporting events to an event tracking service, such as server 107 in FIG. 1. The method may be performed by a user device such as cell phone 101 or laptop computer 103. At block 301, the method identifies an event to be reported to the server. Identifying an event may occur in a number of ways. For example, the user device may be configured to identify as an event a text message being sent or received by the user device. The user device may be further configured to identify as an event a text message sent or received during a time interval (e.g., afternoons and evenings), to or from a particular user (e.g., text messages to friends, not to co-workers), or the user device may be configured not to identify text messages as events.

At block 303, the method converts an identified event into a universal event record (UER). One embodiment of a UER is described in greater detail below in conjunction with FIG. 4. Converting an event into a UER may include mapping various fields of an event data structure into a UER data structure. Other data sources may be used to fill the UER data structure as well. At block 305, the method transmits the universal event record to the server. For example, cell phone 101 may transfer a UER to server 107 through a cellular data network. In another example, laptop computer 105 transfers a UER to server 107 through a residential internet connection (e.g., a cable modem).

FIG. 4 is a diagram illustrating one embodiment of a universal event record. UER 400 includes a device_id 401, which may be used to identify the device that generated the UER. For example, if a cell phone sends a text message, the device_id 401 would identify the cell phone. The device_id 401 would also identify the cell phone if the UER corresponds to a text message received by the cell phone. That is, the device_id 401 identifies the device that generated the UER, not necessarily the device that originated the event. Event_type 403 may be used to specify what type of event is described by the UER. Possible event types include text message (SMS), multimedia message (MMS), email, file transfer, instant message, phone call, and video chat. Other events may be used as well. For example, if the user participates in a social networking system, the user's status updates may be considered events and reported to the server in a UER. The event type may be “arbitrary,” that is, not corresponding to a particular communication service, but rather some data the user wants to insert into the historical collection. For example, the user may want a line of text in the historical collection that indicates the user has boarded a flight, but the user does not wish to use the existing communication services. These “arbitrary” events may include different types of data.

The time_of_event 405 may be used to store a timestamp corresponding to the event described by the UER 400. The timestamp may be taken from the event itself (e.g., a data structure of an email or text message) or may be generated by the user device such that the timestamp corresponds to when the user device sent or received an email. Event_data 407 may be used to store data corresponding to the event described by the UER. For example, if the event is a text message, the event data may include the text portion of the text message. User_id 409 may be used to identify a user associated with the user device that generated the UER 400. The user_id 409 may be used by a server to associate the UER with a historical collection belonging to the user.

Account_id 411 may be used to specify an account corresponding to the source of the event. For example, an instant message is generally associated with two accounts: the sender's account and the receiver's account. The account is the user's identity with respect to the instant message service.

Link_to_content 413 may be used to store a hyperlink (e.g., a URL) to content related to the event described by the UER. For example, a UER describing a video chat may not include the video data in event_data 407 due to size and bandwidth concerns. Instead, a hyperlink to the video data may be provided in link_to_content 413. Type_of_content 415 may be used to indicate the type of content linked to by link_to_content 413, such as video data, audio data, image data, etc.

Event_sender 417 may be used to identify a user or device that sent the event. If the user device creating the UER sent a text message, the user device would be the event_sender and the user device that received the text message would be event_receiver 419. In some embodiments, the UER 400 is created and sent to the server asynchronously from sending or receiving the event described by the UER 400. In one embodiment, Sync_event_flag 421 may be used by the user device to indicate whether the UER 400 has been successfully transmitted to the server. In other embodiments, sync_event_flag 421 is not part of UER 400.

The UER can be a record that can be considered to be in a universal format in one embodiment, because it can be viewed or edited by a plurality of text or web browsers or viewers or because the record was converted from a native format (e.g., an SMS or text message format) to another format that can be viewed by a text or web browser such as Safari or Internet Explorer or Firefox, etc. In one embodiment, the universal format can be a common format.

FIG. 5 is a diagram illustrating the display of a requested portion of a user's historical collection. Title 501 indicates that the requested portion includes events between Bill and Bob, where Bob is the user requesting the portion of the historical collection. Text message 503 is Bill's initial message to Bob, and text message 505 is Bob's response. In text message 507, Bill asks Bob to view a photo. Photo 509 corresponds to a file transfered from Bill to Bob, but is included in its proper chronological order relative to text messages 503-507. Arrow 511 may receive user input 513 and cause a thumbnail 515 of the photo 509 to be displayed.

FIG. 6 is a diagram illustrating the display of a different requested portion of Bob's historical collection. Title 601 indicates that Bill is communicating with Bob. Instant message 603 through 607 correspond to communication between Bill and Bob through an instant message service. Video 609 uses an arrow control 611 to display a video 619 along with play button 615 and scan control 617. By sending user input 613 to arrow control 611, video content 619 may be displayed.

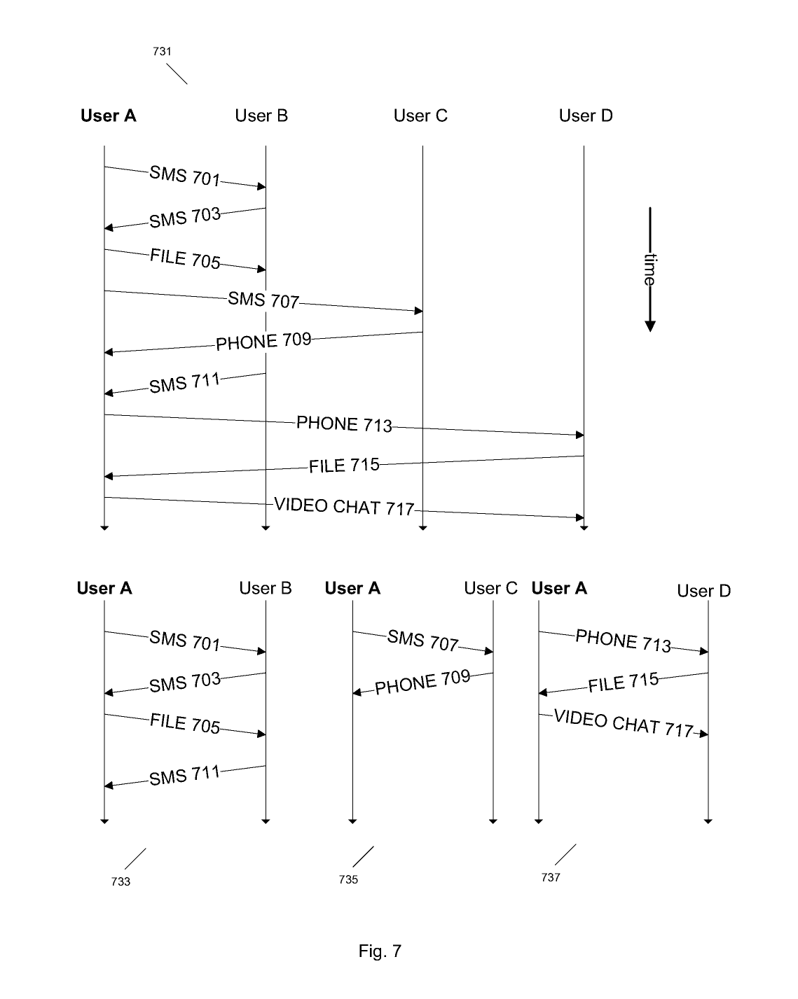

FIG. 7 is a timing diagram illustrating an overall collection view 731 which lists all of the events recorded in user A's history for a period of time. User A exchanged SMS's 701 and 703 with user B, along with file transfer 705. User A exchanged SMS 707 and phone call 709 with user C before receiving SMS 711 from user B. User A then exchanged phone call 713, file transfer 715, and video chat 717 with user D. Collection view 733 is a filtered view that is limited to events exchanged between user A and user B, while view 735 is user A and user C, and view 737 is user A and user D. Views 733-737 illustrate some of the possible views of the overall collection 731.

FIG. 8 shows one example of a data processing system which may be used with one embodiment the present invention. Note that while FIG. 8 illustrates various components of a computer system, it is not intended to represent any particular architecture or manner of interconnecting the components as such details are not germane to the present invention. It will also be appreciated that network computers, tablet computers, and other data processing systems which have fewer components or perhaps more components may also be used with the present invention.

As shown in FIG. 8, the computer system 800, which is a form of a data processing system, includes a bus 803 which is coupled to a microprocessor(s) 805 and a ROM (Read Only Memory) 807 and volatile RAM 809 and a non-volatile memory 811. The microprocessor 805 is coupled to cache 804. The microprocessor 805 may retrieve the instructions from the memories 807, 809, 811 and execute the instructions to perform operations described above. The bus 803 interconnects these various components together and also interconnects these components 805, 807, 809, and 811 to a display controller and display device 813 and to peripheral devices such as input/output (I/O) devices which may be mice, touch screens, touch pads, touch sensitive input devices, keyboards, modems, network interfaces, printers and other devices which are well known in the art. Typically, the input/output devices 815 are coupled to the system through input/output controllers 817. The volatile RAM (Random Access Memory) 809 is typically implemented as dynamic RAM (DRAM) which requires power continually in order to refresh or maintain the data in the memory.

The mass storage 811 is typically a magnetic hard drive or a magnetic optical drive or an optical drive or a DVD RAM or a flash memory or other types of memory systems which maintain data (e.g., large amounts of data) even after power is removed from the system. Typically, the mass storage 811 will also be a random access memory although this is not required. While FIG. 8 shows that the mass storage 811 is a local device coupled directly to the rest of the components in the data processing system, it will be appreciated that the present invention may utilize a non-volatile memory which is remote from the system, such as a network storage device which is coupled to the data processing system through a network interface such as a modem, an Ethernet interface or a wireless network. The bus 803 may include one or more buses connected to each other through various bridges, controllers and/or adapters as is well known in the art.

FIG. 9 shows an example of another data processing system which may be used with one embodiment of the present invention. The data processing system 900 shown in FIG. 9 includes a processing system 911, which may be one or more microprocessors, or which may be a system on a chip integrated circuit, and the system also includes memory 901 for storing data and programs for execution by the processing system. The system 900 also includes an audio input/output subsystem 905 which may include a microphone and a speaker for, for example, playing back music or providing telephone functionality through the speaker and microphone.

A display controller and display device 907 provide a visual user interface for the user; this digital interface may include a graphical user interface which is similar to that shown on a Macintosh computer when running OS X operating system software. The system 900 also includes one or more wireless transceivers 903 to communicate with another data processing system, such as the system 800 of FIG. 8. A wireless transceiver may be a WiFi transceiver, an infrared transceiver, a Bluetooth transceiver, and/or a wireless cellular telephony transceiver. It will be appreciated that additional components, not shown, may also be part of the system 900 in certain embodiments, and in certain embodiments fewer components than shown in FIG. 9 may also be used in a data processing system.

The data processing system 900 also includes one or more input devices 913 which are provided to allow a user to provide input to the system. These input devices may be a keypad or a keyboard or a touch panel or a multi touch panel. The data processing system 900 also includes an optional input/output device 915 which may be a connector for a dock. It will be appreciated that one or more buses, not shown, may be used to interconnect the various components as is well known in the art. The data processing system shown in FIG. 9 may be a handheld computer or a personal digital assistant (PDA), or a cellular telephone with PDA like functionality, or a handheld computer which includes a cellular telephone, or a media player, such as an iPod, or devices which combine aspects or functions of these devices, such as a media player combined with a PDA and a cellular telephone in one device. In other embodiments, the data processing system 900 may be a network computer or an embedded processing device within another device, or other types of data processing systems which have fewer components or perhaps more components than that shown in FIG. 9.

In the foregoing specification, universal communication history has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method comprising:
receiving, by a data processing system, a record of an event in a common format, wherein the record includes a time of the event, a type of the event, and an identity of a device and wherein the device created the record in the common format using an event creation module selected using the type of event and the device transmitted the record to the data processing system;
managing a collection of records including the received record; and
providing a portion of the collection of records in response to a user request, wherein the portion is configured to be sorted according to a user-configurable criteria, and wherein the portion includes records with a plurality of types.

2. The method of claim 1, wherein the type of the event is one of a text message, a multimedia message, an email, a file transfer, a phone call, a calendar event, and a video chat.

3. The method of claim 1, wherein the user request specifies the requested portion of records using a criteria.

4. The method of claim 3, wherein the criteria comprises at least one of a time range, a user identity, and an event type.

5. The method of claim 4, wherein sorting the portion by time range causes the sorted portion to interleave records of different types.

6. A method comprising:
detecting, by a data processing system, an event;
selecting a event creation module based on a type of the event;
causing the selected event creation module to generate a record of the event in a common format, wherein the record includes a time of the event, a type of the event, and an identity of the data processing system;
transmitting the record to a server, wherein the server maintains a collection of records from a plurality of data processing systems and wherein each record in the collection of records is in the common format.

7. The method of claim 6, wherein detecting the event comprises detecting that the data processing system has sent one of a text message, a multimedia message, and an email.

8. The method of claim 7, wherein detecting the event further comprises detecting that the data processing system has received one of a text message, a multimedia message, and an email.

9. The method of claim 6, wherein the transmitting the record to a server is performed by a process separate from a process that generated the event.

10. The method of claim 6, wherein the data processing system is a cellular telephone and wherein the event is a text message received by the cellular telephone.

11. A non-transitory machine readable storage medium storing executable instructions which, when executed by a processor, cause the processor to perform operations, the operations comprising:
identifying, in response to a request from a user device, a subset of a collection of records specified by the request, wherein each record is in a common record format;
sorting the subset according to criteria specified in the request;
transmitting the sorted subset to the user device.

12. The non-transitory machine readable storage medium of claim 11, the operations further comprising:
receiving a plurality of records in the common format from at least one source, wherein the common format includes a type, and wherein the plurality of records includes a plurality of types; and
storing the plurality of records in the collection of records.

13. The non-transitory machine readable storage medium of claim 12, wherein the plurality of types comprises text messages, multimedia messages, emails, file transfers, phone calls, and video chats.

14. The non-transitory machine readable storage medium of claim 13, wherein phone calls include phone calls made through a cellular voice network and voice over IP calls made over an internet data connection.

15. The non-transitory machine readable storage medium of claim 12, wherein the criteria is a chronological order and wherein the chronological order causes the sorted subset to interleave records of different types.

16. A non-transitory machine readable storage medium storing executable instructions which when executed by a processor cause the processor to perform operations, the operations comprising:
identifying an event configured to be stored in a historical collection;
converting the event from an event-specific format into a common event record; and
transmitting the record to a server maintaining the historical collection.

17. The non-transitory machine readable storage medium of claim 16, wherein identifying the event comprises:
determining an attribute of the event, wherein the attribute is one of a type of the event and a creator of the event;
comparing the attribute to a predetermined list of events to be stored in the historical collection; and
selecting the event for storage in the historical collection if the predetermined list of events indicates that the event is to be stored in the historical collection.

18. The non-transitory machine readable storage medium of claim 16, wherein converting the event comprises copying one of content and a link to content into a corresponding field of the common event record.

19. The non-transitory machine readable storage medium of claim 16, wherein the type of the event is one of a text message, a multimedia message, a phone call, a voice chat, a file transfer, and a social networking update.

20. The non-transitory machine readable storage medium of claim 16, wherein the identifying the event occurs in response to one of receiving the event and transmitting the event.

21. An apparatus comprising:
means for detecting that an event to be recorded in a historical collection of events has occurred;
means for converting the event from an event-specific format into a record in a common format;
means for storing the record in the historical collection of events;
means for generating a subset of the historical collection in response to a request, wherein the subset is sorted according to a requested criteria; and
means for delivering the subset.

22. The apparatus of claim 21, wherein detecting the event comprises receiving a notification that a text message has been sent or received.

23. The apparatus of claim 21, wherein converting the event comprises invoking an event creation module selected based on a type of the event;

24. The apparatus of claim 21, wherein generating the subset comprises filtering the historical collection of events using one or more criteria specified in the request.

25. The apparatus of claim 24, wherein the one or more criteria comprises a time range and a user identity.
